(19) United States
(12) Patent Application Publication
(10) Pub. No.: US 2003/0158698 A1
(43) Pub. Date: Aug. 21, 2003

(54) Monitoring system

(76) Inventor: Richard Glazerbrook, Leicestershire (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/221,952

(22) PCT Filed: Mar. 14, 2001
(86) PCT No.: PCT/GB01/01096

(30) Foreign Application Priority Data
Mar. 15, 2000 (GB) 0006103.6
Mar. 31, 2000 (GB) 0007824.6

(51) Int. Cl. G01L 19/12; G01F 22/02

(52) U.S. Cl. 702/140; 73/149; 73/714; 702/156

(57) ABSTRACT

Bottle (11) containing liquefiable gas stored under pressure is supplied to one or more appliances (12) via regulator (14) and condut (16). Sensing means (120) incudes sensor (20) and remote temperature sensor (40). Monitor (30) contains micro processor (300) and indication means (32) to have a number of modes including power-saving, stand-by, normal, amber, red/amber, mute, leak test and low battery.

The present invention relates to a monitoring apparatus and a method for monitoring different predefined operating conditions of a storage container containing a liquid/gas mixture stored under pressure, in particular but not exclusively a system which utilises a source of gas stored as a liquid under pressure in a container.

The monitoring apparatus of the present invention is particularly applicable for use in systems using liquefiable gases such as butane or propane or predefined mixtures thereof.

According to one aspect of the present invention there is provided a monitoring apparatus for indicating a plurality of different predefined operating conditions of a storage container containing a liquid/gas mixture stored under pressure, the monitoring apparatus including electrically operable indication means for indicating said plurality of different predefined conditions, sensing means for sensing the pressure of said gas and which produces electrical signals indicative of the sensed pressure, computer processing means operatively connected to said sensing means to receive said electrical signals, said processing means being arranged to process said signals to produce a plurality of different output control signals which selectively control said indication means to indicate a selected one of said predefined operating conditions.

According to another aspect of the present invention there is provided a method for determining a plurality of different predefined operating conditions of a storage container containing a liquid/gas mixture stored under pressure, the method including sensing the pressure of said gas to produce electrical signals indicative of the sensed pressure, feeding said electrical signals to a computer processing means which is programmed to process said electrical signals with reference to currently or previously received electrical signals to produce a plurality of different output control signals and using said output control signals to control indication means to indicate a selected one of said predefined operating conditions.

Various aspects of the present invention are hereinafter described with reference to the accompanying drawings, in which:—

FIG. 1 is a schematic diagram of a bottled gas system including a monitoring apparatus according to the present invention;

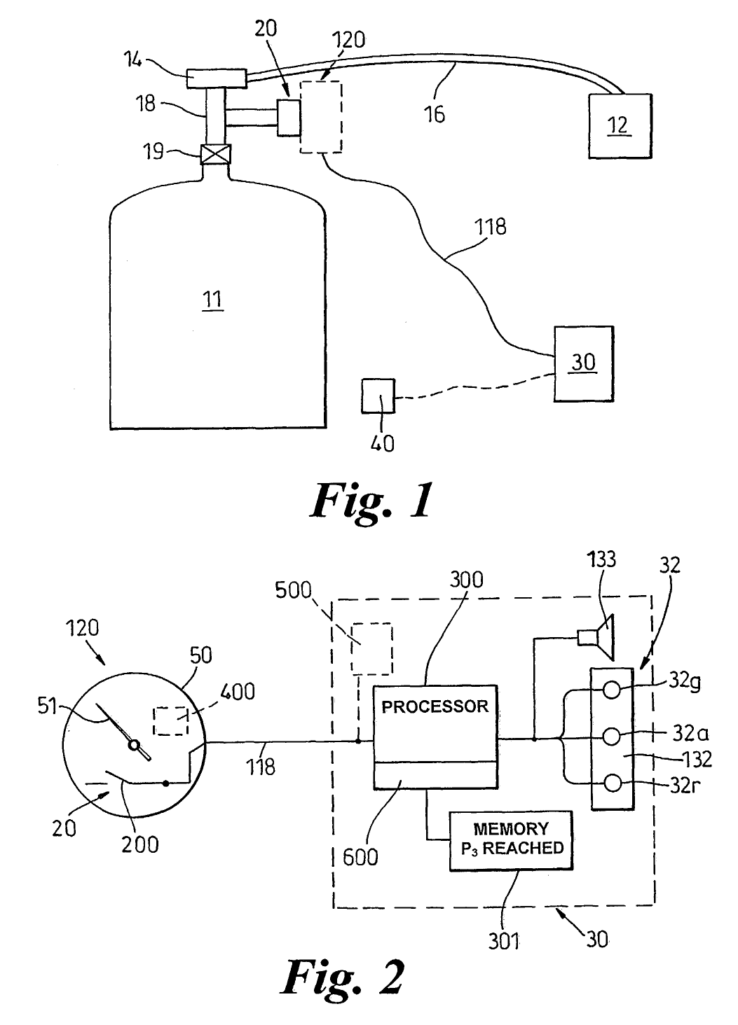

FIG. 2 is a diagram illustrating component parts of the first embodiment;

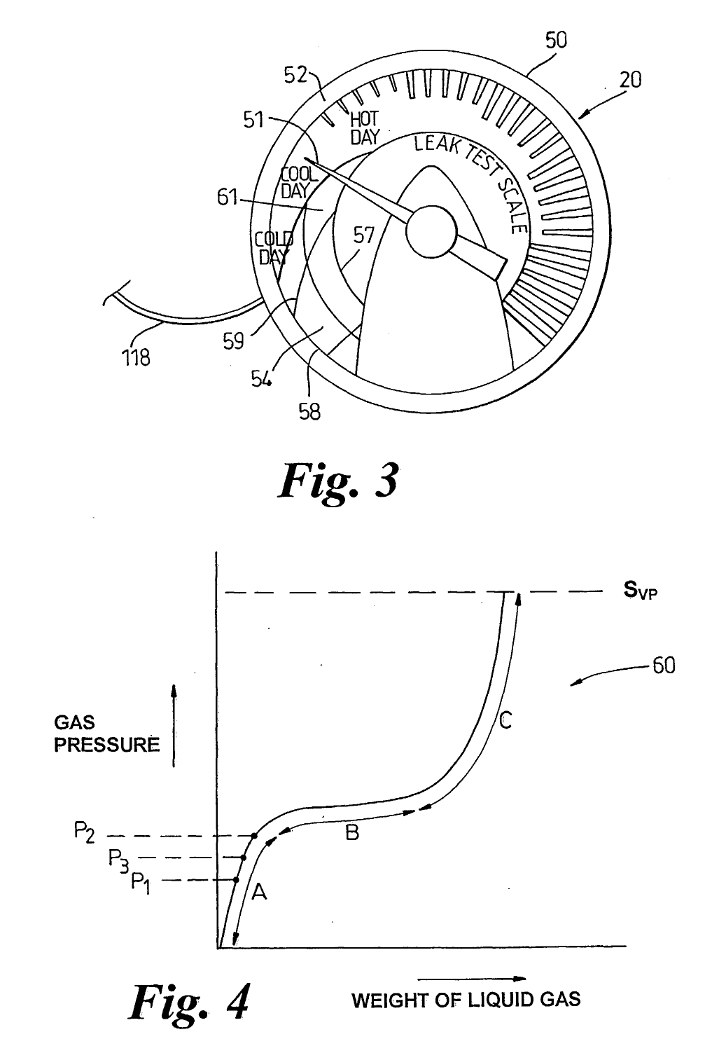

FIG. 3 is a front view of a sensing means forming part of a monitoring apparatus according to a first embodiment of the present invention;

FIG. 4 is a diagrammatic plot of bottle gas pressure v. weight of liquid gas remaining in the bottle;

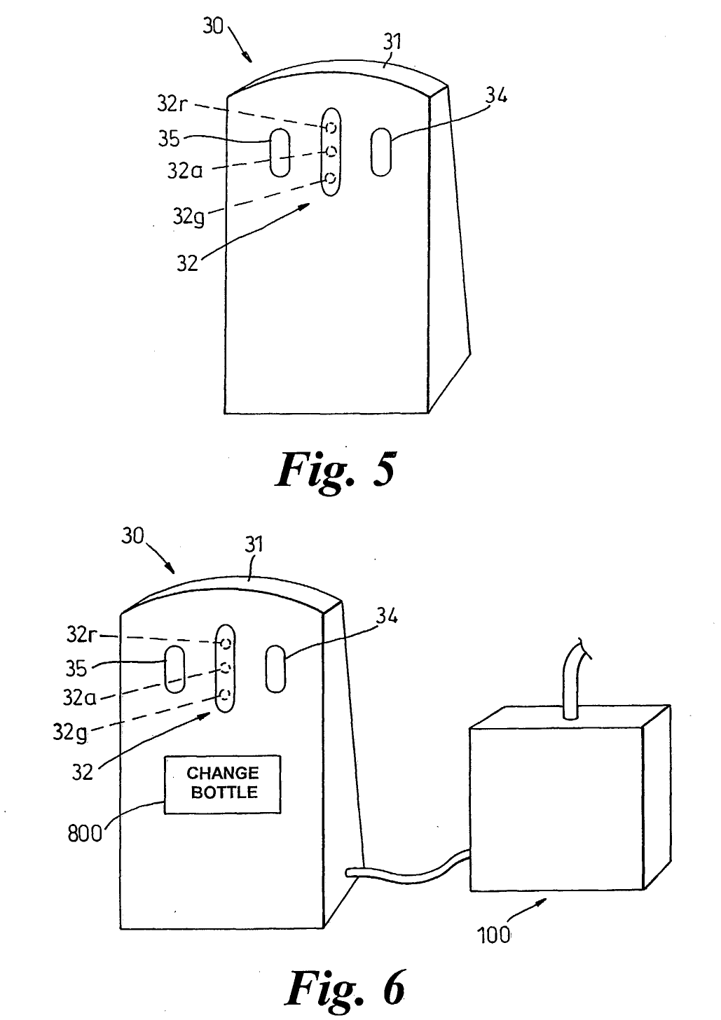

FIG. 5 is a schematic perspective view of a monitor forming part of the monitoring apparatus according to the first embodiment;

FIG. 6 is a schematic perspective view of a monitor forming part of the monitoring apparatus according to a second embodiment; and

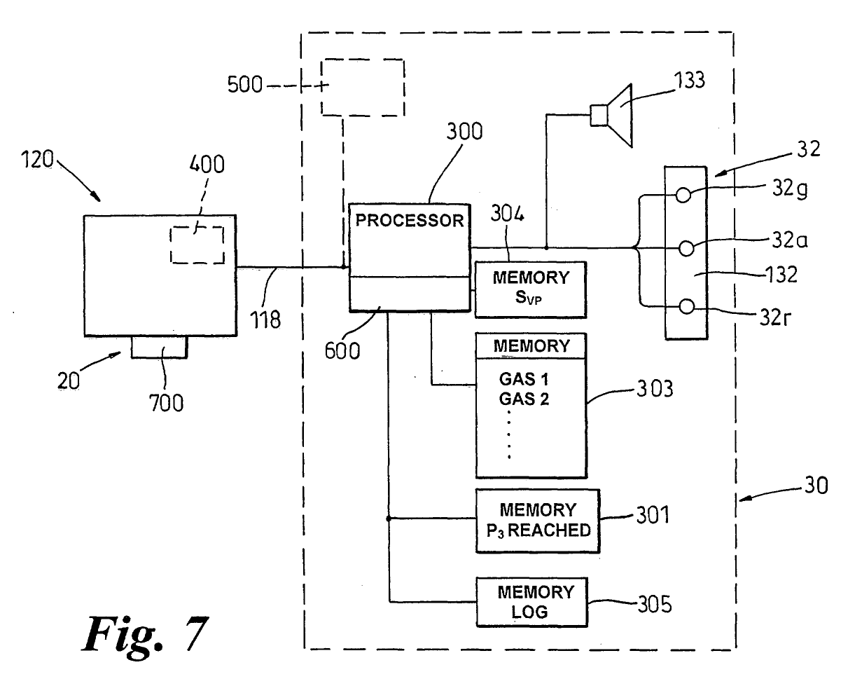

FIG. 7 is a diagram illustrating component parts of the second embodiment.

The bottled gas system shown in FIG. 1 includes a storage container 11, herein referred to as a bottle, which contains liquefiable gas (such as butane, propane or a predefined mixture of butane/propane) stored under pressure.

Gas is supplied to an appliance 12 via a regulator 14 and conduit 16. Clearly there may be any number of separate appliances 12.

The regulator 14 acts to reduce the pressure of the gas supplied to the appliance 12 as it is drawn from the bottle 11. Accordingly, the system has a low pressure side located on the downstream side of the regulator 14 and a high pressure side located on the upstream side of the regulator 14.

The regulator 14 is connected to the bottle 11 via a conduit 18 and an isolation valve 19.

In accordance with the present invention there is provided sensing means 120 including a sensor 20 located at a position to sense the gas pressure and optionally the temperature of the gas located on the high pressure side of the regulator. Conveniently, sensor 20 communicates with conduit 18 for this purpose.

The sensing means 120 preferably also includes a temperature sensor which is responsive to sense the ambient temperature surrounding the bottle. The ambient temperature sensor may be incorporated in a common housing with sensor 20, or as indicated in FIG. 1, the temperature sensor 40 may be remote from sensor 20.

A monitor 30 containing computer processing means 300 and indication means 32 is provided. The computer processing means 300 is preferably a semi-conductor microprocessor which stores its own unique program. The sensing means 120 is arranged to produce electrical signals indicative of sensed gas pressure, and if provided, gas and/or ambient temperature to the processing means 300 of the monitor 30. The sensing means 120 may be operatively connected with the processing means via a ‘hard’ connection e.g. electrical wire 118 or may be remotely operatively connected by telemetry e.g. radio frequency communication. In the latter case, the sensing means 120 is provided with a radio frequency transmitter 400 and the monitor 30 is provided with a suitable receiver 500.

Since the signals from the sensing means 120 are transmitted either along a wire 118 or by telemetry, the monitor 30 may be located at a remote position away from the bottle 11. This is particularly useful in caravans or boats since it means that the remote monitor 30 may be located at a convenient position within the interior of the caravan or boat which is readily accessible for reading the monitor 30.

In accordance with a first embodiment of the present invention, the sensor 20 is a pressure operated electrical switch 200 (FIG. 2) incorporated within a mechanical gauge 50 (FIG. 3) and produces a signal indicative of a predetermined gas pressure only.

The gauge 50 includes a pointer 51 which moves over a dial face 52 in response to changes in sensed pressure. The dial face 52 is calibrated in accordance with the bottle gas pressure v. weight of liquefied gas relationship as disclosed in our European patent 0052609.

A graph 60 illustrative of this relationship is shown in FIG. 4. The dial face 52 includes a first zone 54 which indicates to a user when the sensed pressure has fallen below a first predetermined pressure, P₁, which is preferably located in region A of graph 60. When the pointer 51 enters zone 54, it visually indicates to the user that only a predetermined small quantity of liquefied gas remains and so indicates that the bottle 11 should be changed.

It is recognised that ambient temperature can influence the gas pressure within the bottle. In order to compensate for this the inside boundary edge 57 of zone 54 is calibrated at a high temperature (indicated as ‘HOT DAY’) and the outside boundary edge 58 is calibrated at a low temperature (indicated as ‘COLD DAY’). Optionally, a line indicating ‘COOL DAY’ is located inbetween edges 57, 58.

Preferably, a second zone 61 is provided adjacent to zone 54 to indicate when the gas pressure has fallen below a second predetermined pressure, P₂, which, at a given temperature, is higher than pressure P₁. Preferably pressure P₂ is located in the region A or B of graph 60.

As indicated above, the gauge 50 includes sensor 20 in the form of an electrical switch (200) which is activated when the gauge 50 senses a pressure at or below a third predetermined pressure, P₃. For example, in the case of propane, P₃ may be set at about 70 psi.

Preferably at a given temperature, the third predetermined pressure, P₃, is higher than pressure P₁. Pressure P₃ may or may not be higher than pressure P₂. Conveniently, the switch 200 is mechanically activated by the drive mechanism of the gauge 50 which is responsible for driving the pointer 51.

Preferably, the monitor 30 includes a hermetically sealed casing 31 for housing the computer processing means 300 and the indicating means 32. Preferably the indicating means 32 includes a visual display 132 and also preferably includes an audible means 133 such as a buzzer/speaker for providing an audible warning. Preferably the visual display 132 includes three switchable lights, preferably in the form of light emitting diodes. Preferably the warning lights are a red LED 32r, an amber LED 32a and a green LED 32g.

Preferably the monitor 30 also includes two electrical switches 34 and 35 operatively connected to the computer processing means. Preferably the switches 34, 35 are of the push-button type and perform different functions in dependence on how long the push-button is depressed. The processor 300 is provided with a re-settable memory 301 and preferably switch 34 selectively functions to switch power on and to cause the processing means 300 to re-set the memory 301. Preferably, switch 35 selectively functions to mute audible indications and to cause the processing means to enter a leak test mode.

Preferably the electrical circuit (including the processor and indication means) of the monitor is powered by batteries. Preferably the monitoring apparatus of the first embodiment functions in the following manner;

1. Ample Supply of Liquefied Gas (Warning 1)

If the gas bottle connected has sufficient contents the processor causes the indication means to provide a unique visual display indicative of this condition (display 1). In this respect the GREEN LED 32g is caused to flash once every 15 seconds to signify the contents are above the sensor pressure threshold (ie. above pressure P₃). Ps 2. Supply of Liquefied Gas Running Low (Warning 2)

The first time the sensor 20 detects a low gas pressure caused by the switch 200 being switched when the gas pressure falls to pressure P₃, an output signal from the sensor 20 is fed to the processor and in response thereto, the processor 300 controls the indication means to provided a unique display indicative of this condition (display 2). In this respect the AMBER LED 32a is caused to flash every 10 seconds and the buzzer/speaker is caused to beep every 30 seconds. If desired, the audible alarm may be silenced by pressing the MUTE switch 35 button (for less than 1 second).

This warns the user that the supply of gas is beginning to run low and that they should look at gauge 50 for a reading.

3. Continued Use of Bottle when Gas Supply is Running Low (Warning 3)

It is possible for the gas pressure to rise after first falling to pressure P₃. This could arise due to an increase in ambient temperature or a reduction in the consumption of gas.

When such an increase in gas pressure occurs, the processor 300 is preferably programmed so as not to change the display to indicate that low pressure P₃ has been previously reached and that the operative should continue to consult the gauge.

This is preferably achieved by the processor including re-settable memory 301 and the processor being programmed to store in memory 301 data indicative of the sensor 20 having sensed pressure P₃ for the first time.

Thus when the processor is fed with an electrical signal from the sensor 20 (as a result of the sensor 20 sensing the gas pressure falling to P₃ for a second or subsequent time), the processor 300 controls the indicating means to display a unique visual display indicative of this condition (display 3). In this respect, the red LED 32r and amber LED 32a are caused to flash alternat ely say every 5 seconds and the audible means 133 are caused to sound every 20 seconds.

It will be appreciated from the above, that the processor 300 receives electrical signals from the sensor 20 and in response thereto and with reference to either the currently received signal or a previously received signal controls the indication means to display one of three unique displays (displays 1, 2 or 3) in dependence upon the sensed pressure; each unique display conveying to the user unique information concerning the operating condition of the bottle.

Preferably the processor 300 includes a timer 600. This enables the monitor 30 to perform a leak test on the gas system between the bottle 11 and appliances 12.

The leak test is performed by opening valve 19 to fully pressurise the gas system, then closing valve 19 and then switching the processor 300 to a leak test mode.

Once in leak-test mode the monitor 30 monitors the pressure held within the system for a predefined fixed period of time, say 15 minutes, and during this time period the processor causes the indicating means to show a unique visual display indicative of this condition (display 4). In this respect all three LED's 32r, 32a and 32g are caused to flash alternately.

The set period of time is chosen to be of a sufficiently long duration to enable the gas pressure to fall to pressure P₃ due to a small leak, for example 15 cc per hour, on the downstream side of regulator 14.

At the end of the test period the processor produces output signals in response to sensor 20 to control the indication means to indicate by unique displays whether the gas system has passed or failed the leak test. A fail condition may be indicated by the processor 300 causing the RED LED 32r and the audible sound to be on constantly. This condition will be detected due to switch 200 being closed on reaching pressure P₃ during the test period. In order to indicate that the monitor 30 is in test mode after completion of the failed test, the processor 300 preferably causes the green and amber LED's 32g and 32a to flash alternately.

The RESET button must now be pressed to cancel leak test mode.

A second leak test should be performed after the leak has been rectified.

If at the end of a test period the switch 200 remains open, i.e. the sensed pressure has not fallen to pressure P₃ , the processor 300 causes the indication means to indicate that the test has been passed. The processor causes the indication means to display a further unique display indication of this condition. In this connection the green LED 32g is continuously illuminated and the red and amber LED's 32r, 32a are caused to flash alternately to signify that leak test mode is still enabled.

The RESET button must now be pressed to cancel leak test mode.

In order to perform the above functions, the microprocessor (ie. chip) is preferably programmed to have the following modes, viz.

1) Power saving mode—the chip is asleep and drawing very little power when any LED is off and ‘wakes-up’ to give the necessary signal to the relevant LED, any change in input status; ie. change of gas sensor condition, is acted upon instantly—as this wakes up the chip. The input state must have been changed for more than 1 second to prevent false triggering and erroneous changes in gas level.

2) Stand-by mode—the chip is put to permanent sleep in STAND-BY and no LED's are activated, this maintains consumption at an ultra-low level and the unit will remain in this mode for several years, for storage/non-use periods.

3) Normal mode—the GREEN LED flashes every 15 seconds when the gas level is above the setpoint, P₃, ie. approximately 20 to 100% full.

4) Amber mode—this is the first level of warning, ie. the gas sensor has opened to signify that the gas level has fallen below the threshold of the sensor for the first time, this may be caused in several conditions; low level in normal use, a sudden surge in demand, the temperature effect from change in ambient conditions (when the bottle is nearing empty), or in a burn-off situation.

NB: This will be the only warning if the bottle is connected to a system which is dissipating slowly at a constant rate at a stable ambient temperature.

5) Red/Amber mode—this is the second level of warning (this will not occur if the contents are just dissipating slowly whilst in constant use at a fixed ambient temperature). Should the sensor threshold be breached for a second time, this may be caused in several conditions; system being switched off and back on after amber mode has occurred in use; the contents of the bottle varying with temperature and the bottle pressure varying around the threshold and burn-off causing varying level of gas.

6) Mute mode—whilst mute is activated the LED's continue to operate and the sounder is silent to prevent annoyance to the user, ie. at night in a caravan.

7) Leak test mode—in leak test mode the LED's oscillate sequentially to confirm this mode is enabled, the chip monitors the state of the sensor and acts accordingly (as per paragraph 5 above). If a pass situation occurs the user is reassured that no major leak has been detected but should look at the gauge on the bottle to validate that no leak has occurred. In a fail situation the chip raises the alarm and the user must rectify the leak and repeat the leak test.

8) Low battery mode—the chip constantly monitors the state of the batteries and when a threshold is reached where the functionality of the chip may be affected, the chip gives early warning via a double flash to the RED LED, every 5 seconds accompanied by a sounder beep.

A main benefit of the monitor is to provide a visual and/or audible indication which indicates the sensed pressure is at or below P₃ and so give the user a warning to inspect the gauge 50 and take a reading. In this way, the user is given positive prior warning that the gauge 50 is sensing pressure indicative of the amount of liquefied gas remaining in the bottle becoming low, but not necessarily so low that the bottle requires replacement.

After being given the prior warning, the user then knows that it is necessary to closely monitor readings from the gauge 50 so as to determine when to change the bottle.

This is particularly advantageous, as in the majority of systems, the bottle 11 is normally stored in a cupboard and so is usually out of sight to the user.

As indicated above, optionally, the electrical circuit in the monitor 30 includes an electronic memory which functions to memorise when the prior warning has been given. Accordingly, if after the gauge 50 has activated the switch, the system becomes inactive, eg. all appliances are switched off and/or the close-off valve is closed, the gas pressure within the bottle 11 will rise to the saturation vapour pressure Sᵥₚ. This will cause the gauge 50 to sense a high pressure and so inactivate the switch. When the system is subsequently used, the sensed pressure may initially be above the predetermined pressure P₃ and so the switch remains inactive.

However, in response to the memory, the monitor 30 is arranged to indicate, by way of a visual and/or audible indication, that during the previous use of the system, the switch had been activated, and so reminds the user to closely monitor the gauge 50.

This facility is also particularly useful to the user in dealing with a ‘burn-off’ situation, ie. a situation where the use of a large number of appliances causes gas to be consumed at a high rate and so, when a small amount of liquefied gas remains in the bottle 11, causes the bottle gas pressure to rapidly fall below the first predetermined pressure P_{1.}

By giving a warning when the pressure P₃ is sensed, the user if using a large number of appliances is given notice to reduce use of a large number of appliances in order to conserve consumption of gas.

In accordance with a second embodiment of the present invention, the gauge 50 is replaced by a sensor, in the form of a transducer 700, capable of continually sensing changes in gas pressure within the bottle 11 over a predetermined range of pressures; the predetermined range of pressures preferably being from zero to a maximum pressure which is in excess of the expected maximum pressure of the gas in bottle 11. Optionally also sensing temperature of the gas flowing from the bottle 11. The sensor 700 is preferably a ceramic diaphragm and provides a linear output signal proportional to the gas pressure, and if provided, temperature, and so provides the processor 300 with signals indicative of actual values of pressure and temperature.

The second embodiment is arranged to operate in a similar manner to the first embodiment in order to provide unique visual and/or audible indications specific to different operating conditions.

As indicated in FIG. 7, the monitor 30 of the second embodiment preferably includes additional memories 303, 304. Preferably memory 303 contains data which is representative of the gas pressure v. weight of liquid graphs 60 of a plurality of different liquefiable gases such as propane or butane or predefined mixtures of propane and butane.

When monitoring the gas system during normal use, the processor 300 is arranged to process the signals received from the pressure sensor 700 by making reference to the stored graph 60 which corresponds to the liquefiable gas in bottle 11.

To enable the processor 300 to determine which stored graph 60 to use, memory 304 contains data corresponding to the saturation vapour pressure of the plurality of different liquefiable gases at different typical ambient temperatures. The processor 300 is programmed, when reset, to compare the sensed pressure with the saturation vapour pressures stored in memory 304. This comparison enables the processor 300 to determine the gas/gas mixture stored in the bottle and thereby determine which stored graph 60 to interrogate. In a variant for use with only one type of gas, this step is pre-programmed, and actuable by pressing the button for e.g. 15 seconds

Accordingly by pressing a reset button on the monitor, the monitor 30 senses the pressure and temperature and, in effect, looks up the stored values in order to determine which gas is stored in the bottle 11. Thereafter the monitor functions on the basis of the newly determined gas until being reset again.

This feature is particularly advantageous when changing from using one gas to another (such as from butane to propane) as it means that the same monitor may continue to operate without the need for replacement.

In accordance with the second embodiment, the monitor 30 is preferably arranged to indicate when the gas pressure in the container 11 has dropped below the minimum predetermined pressure P₁ so as to indicate to the user that the predetermined minimum quantity of liquid gas remains in the container 11 and therefore give warning that the container should be replaced. This warning signal is referred to herein as the‘change bottle’ warning signal. In this embodiment, the processor 300 may cause the red LED 32r to light up continuously to indicate ‘change bottle’.

Leak detection may be performed with the second embodiment in a similar manner to that in the first embodiment viz. after opening and closing the isolation valve and starting the leak detection cycle, the monitor 30 then monitors the sensed pressure and over a period of time, say 3 minutes, determines whether or not the sensed pressure has fallen below a predetermined minimum. During this time, all LED's 32r, 32a and 32g may flash to show that a leak test is being conducted.

If during that period of time the pressure has not fallen below the predetermined minimum pressure, the monitor 30 is programmed to indicate (by use of a suitable visual indicator or sound) that no leak has been detected. The visual indication may take the form of the green and amber LED's flashing.

If during that period of time the pressure has fallen below the predetermined minimum pressure, the monitor 30 is programmed to indicate that a leak has occurred.

It is envisaged that by determining the length of time taken to reach the predetermined pressure, the monitor 30 may also indicate whether the leak is a severe leak or a slow leak. For example a severe leak may be visually indicated by the red LED flashing whereas a slow leak may be indicated by both the red and amber LED's flashing.

Alternatively, the processor 300 may be programmed to determined the rate of fall of measured pressure. If after pressuring the system, the processor determines that the measured pressure begins to fall at a rate in excess of a predetermined rate, it will indicate that a leak is present by outputting signals to cause the display to indicate a FAIL. This mode of leak detection is advantageous in that it enables the leak test to be performed relatively quickly rather than over a relatively long fixed, period of time.

Preferably the processor 300 is programmed to determine a ‘burn-off’ situation. This is a situation where the rate of consumption of gas from the bottle is in excess of the rate of replenishment of the gas (by the liquid phase changing to the gas phase) and thereby causing a resultant drop in pressure within the bottle 11. The situation may occur, for example where several appliances are used at the same time.

Whilst the bottle 11 contains a sufficiently large volume of liquid gas (say over half full), the pressure drop is likely to remain in region C of the graph in FIG. 3.

However, when the volume of liquid gas has fallen, say below half full, the burn-off situation may cause the gas pressure in container 11 to fall into region B or into region A.

The processor 300 is preferably arranged to indicate to the user that this situation has occurred. This may take the form of a warning signal (visual and/or audible) which is separate to the signal which indicates that the pressure has fallen below the predetermined pressure in region A.

It will be appreciated that the burn-off situation is dependent upon the rate of consumption of gas by the connected appliances and that after shut down of the appliances, the gas pressure in the container will increase back to the saturated vapour pressure. Thus, if when the system is next used the consumption is substantially less, the burn-off situation will not arise.

Preferably therefore once the burn-off situation has been detected, the burn-off indicator remains active until the processor 300 is reset, for example the visual indication for the burn-off situation may be the amber LED only being lit.

This therefore gives the user a pre-warning to the ‘change bottle’ warning signal and indicates to the user that a heavy consumption can only be sustained for a short period of time.

Preferably the processor 300 is programmed to indicate that the supply of gas from the container 11 is about to fail or has failed due to the temperature of the liquid in the container being insufficient to make available latent heat for converting the liquid phase into the gas phase. This situation is referred to as a ‘freeze-out’ situation. The freeze-out situation may be brought about by the ambient temperature being too low.

Accordingly, an ambient temperature sensor 40 is preferably provided for monitoring ambient temperature. The ambient temperature sensor is arranged to transmit signals to the monitor 30 (by either electrical wiring or radio telecommunication). If the monitor 30 detects that the ambient temperature has fallen below a predetermined low value, and that the gas pressure within the container has also fallen below a predetermined value, it provides a warning signal (either visual and/or audible) to indicate that the fall in gas pressure is due to the low ambient temperature. In such a case, the user is aware that the bottle 11 needs to be warmed in order to restore the gas supply.

It is also possible for the freeze-out situation to be brought about by excessive consumption of gas from the bottle 11.

When gas is drawn from container 11, the liquid gas adsorbs latent heat as the liquid gas changes from its liquid phase to its gas phase. This causes a reduction in temperature of the liquid gas. For a given rate of consumption of gas, the smaller the quantity of liquid, the faster the temperature decreases. It is possible therefore for the temperature of the liquid gas to be lowered to a value where there is insufficient heat for the liquid to change to gas.

It is common for bottles 11 to be made available in a variety of sizes. Accordingly, if the size of bottle 11 is too small for the gas consumption of the system, a freeze-out situation is likely to occur.

Monitor 30 is arranged to detect a freeze-out situation happening caused by the amount of consumption compared to the size of bottle 11.

In this respect, the monitor 30 is arranged to compare the temperature of the gas being drawn from the bottle 11 with the ambient temperature. If the gas temperature falls below a predetermined value compared with the ambient temperature, a freeze-out signal is produced (which may be visual and/or audible) to indicate that there is a danger of a freeze-out.

This indicates to the user to reduce the rate of consumption. If the freeze-out situation re-occurs, it indicates to the user that a larger container 11 should be used, or in a situation where multiple bottles 11 are connected, that more than one bottle 11 should be utilised.

The monitor 30 is preferably also arranged to indicate if an ‘over-pressure’ situation has occurred.

An over-pressure situation is a situation where the pressure within the bottle 11 is above a predetermined maximum value. Such a situation, if not remedied can be dangerous as there is a risk of explosion.

An over-pressure situation can be caused at the time of filling the bottle 11 with liquid gas by filling the bottle 11 with too much liquid.

When the bottle 11 is first connected to the system, the monitor 30 is reset. Preferably part of the resetting program undergone by the monitor is to check the pressure within the bottle 11. If the sensed pressure is above the predetermined maximum pressure, then the monitor 30 is arranged to provide a unique warning signal (visual and/or audible) which indicates that there is an over-pressure situation.

An over-pressure situation can also be caused by the bottle 11 being exposed to a heat source (eg. the sun or an appliance such as a cooker).

As indicated above, the processor 300 is preferably programmed so as to monitor the gas pressure within the bottle during use. Accordingly, if the sensed gas pressure rises to the predetermined maximum pressure during use, the monitor 30 is arranged to provide a unique warning signal (visual and/or audible) which indicates an over-pressure situation has occurred. Since the over-pressure situation has occurred during use, it is highly likely that the rise in temperature has been caused by the appliance. Thus, it is a relatively simple task for the user to take corrective action.

It is envisaged that the processor 300 may be programmed to control an optional autodialer 100 to place a predefined telephone call, e.g. to send a “re-order” signal to an autodialer 100. The autodialer 100 is programmed to respond to the signal from the processor 300 and telephone a predefined supplier of liquefied gas and place an order for replacement gas to be sent to a predefined address.

This is a particularly useful feature for liquefied gas systems used in static environments such as domestic homes or other types of building.

The monitor 30 is preferably programmed so as to send the “re-order” signal to the autodialer when a predetermined pressure has been detected; this predetermined pressure being indicative that there is sufficient liquefied gas present to supply gas to the system for a predetermined time period which is sufficiently long to enable a new supply to be delivered. For example, the predetermined pressure for liquid propane would be about 50 psi. For a multi-bottle installation when using an automatic changeover, the system is calibrated with the changeover so that when it changes from the service bottle to the reserve bottle at about 6 psi, the monitor registeres this and orders a replacement.

In this way it is possible to ensure that the gas system is continually supplied with gas and so provide the user with a gas system which is comparable with one connected to a mains supply.

In this situation, it is envisaged that the supply of liquefied gas may be stored in a large bottle, eg. a 100 lb bottle, or may be stored in a static container, eg. a 420 lb bottle, which is re-filled with liquefied gas on site.

It is envisaged that the processor 300 also includes an optional memory 305 which logs pressure and temperature readings taken over a period of time, e.g. 30 days. The processor 300 is adapted to output the log to enable a gas pressure/quantity curve 60 to be produced and subsequently loaded into the memory 303 of the processor 300. In this way it is possible to calibrate the processor 300 to respond to gas mixtures not previously pre-loaded into the memory and to calibrate for deviations from a predefined graph 60 which might arise from the size of container and operating environment.

It is also envisaged that the indication means 32 may include visual display 800, such as a liquid crystal display, which is capable of providing readable information. If a visual display 800 is provided, the processor 300 is preferably programmed to control the display 800 to display a unique readable message when a predefined operating condition is determined. For example, as illustrated, when the pressure P₁ has been detected, a message ‘change bottle’ is displayed.

The user is therefore given two sources of visual information; namely (i) a coded light/audible display which is meaningful at a relatively large distance from the monitor and (ii) a readable message which is directly meaningful to the user without the need of knowing the ‘code’ for display 32.

When a visual display 800 is provided, it is envisaged that the indication means 32 may be controlled to produce a single display irrespective of the detected system condition in order to alert the user to read the visual display 800 to determine the condition which has been detected.

In the above examples, the indicating means 32 includes three switchable lights; it will be appreciated that two or more than three lights may be provided for use in providing unique displays for indicating each predefined operating condition.

It is envisaged that the sensor 20 may be located within a monitor 130 such that the monitor 130 is located in the vicinity of the bottle 11. The monitor 130 is arranged to function as monitor 30 and so provide local readings at the bottle 11.

It is envisaged that when using radio communication between the sensing means 120 and the monitor 30, that the receiver 500 may be tuned to different transmitters 400 and thereby enable one monitor 30 to monitor the operating condition of several different gas bottle systems.

1. A monitoring apparatus for indicating a plurality of different predefined operating conditions of a storage container containing a liquid/gas mixture stored under pressure, the monitoring apparatus including electrically operable indication means for indicating said plurality of different predefined conditions, sensing means for sensing the pressure of said gas and which produces electrical signals indicative of the sensed pressure, computer processing means operatively connected to said sensing means to receive said electrical signals, said processing means being arranged to process said signals to produce a plurality of different output control signals which selectively control said indication means to indicate a selected one of said predefined operating conditions.

2. A monitoring apparatus according to claim 1 wherein said sensing means continually senses changes of pressure throughout a predetermined range of pressures.

3. A monitoring apparatus according to claim 2 wherein the sensing means additionally senses ambient temperature of the storage container and/or temperature of the gas.

4. A monitoring apparatus according to claim 3 wherein said liquid/gas mixture is a liquefiable gas stored under pressure and said processing means includes memory means having stored therein reference data representative of the gas pressure/liquid quantity curve for said liquefiable gas.

5. A monitoring apparatus according to claim 4 wherein said memory means includes reference data representative of the gas pressure/liquid quantity curve of a plurality of different liquefiable gases or predefined mixtures thereof, said memory further including reference data representative of the saturation vapour pressure of each of said plurality of liquefiable gases and mixtures thereof, said processing means being operable to compare the sensed gas pressure with said reference data representative of said saturation vapour pressure being operable to select, for use in processing said electric signals indicative of the sensed pressure, reference data indicative of the gas pressure/liquid quantity curve of one of said plurality of liquefiable gases and mixtures thereof.

6. A monitoring apparatus according to claim 4 or 5 wherein the processing means stores in said memory means measurement data representative of the sensed pressure and temperature received from said sensing means over a predefined period of time.

7. A monitoring apparatus according to any preceding claim including an automatic telephone dialling means operatively connected to said processing means, said processing means being operable to produce an output control signal to actuate the telephone dialling means to make a predefined telephone call.

8. A monitoring apparatus according to claim 1 wherein the sensing means is an electrical switch in response to the sensed pressure.

9. A monitoring apparatus according to any preceding claim wherein the indicating means includes two or more visual indicators each of which is electrically switchable between an on mode or an off mode, said output control signals being operable to switch each of said visual indicators between its on/off modes in order to produce a unique visual display which is representative of said selected one of said predefined operating conditions.

10. A monitoring apparatus according to any preceding claim wherein said sensing means and processing means are operatively connected by telemetry.

11. A monitoring apparatus according to any preceding claim wherein said processing means and said display means are operatively connected by telemetry.

12. A method for determining a plurality of different predefined operating conditions of a storage container containing a liquid/gas mixture stored under pressure, the method including sensing the pressure of said gas to produce electrical signals indicative of the sensed pressure, feeding said electrical signals to a computer processing means which is programmed to process said electrical signals with reference to currently or previously received electrical signals to produce a plurality of different output control signals and using said output control signals to control indication means to indicate a selected one of said predefined operating conditions.
